(19) United States
(12) Patent Application Publication
(10) Pub. No.: US 2022/0234231 A1
(43) Pub. Date: Jul. 28, 2022

(54) SHEARING TOOL

(71) Applicant: MILWAUKEE ELECTRIC TOOL CORPORATION, Brookfield, WI (US)

(72) Inventors: Samuel J. Krohlow, Wauwatosa, WI (US); Peter J. Bersch, Mequon, WI (US); John D. Nourse, Oshkosh, WI (US); Nathaniel R. Cebula, Stevens Point, WI (US); Jason R. Johnson, West Bend, WI (US)

(21) Appl. No.: 17/552,109

(22) Filed: Dec. 15, 2021

Related U.S. Application Data
(60) Provisional application No. 63/126,361, filed on Dec. 16, 2020.

(51) Int. Cl. B26D 1/30; B26D 7/00; B26D 7/01

(52) U.S. Cl. CPC B26D 1/30; B26D 7/01; B26D 7/0006

(57) ABSTRACT

A shearing tool includes a drive device and a shearing assembly. The drive device includes a housing and an output member linearly movable relative to the housing along a drive axis. The shearing assembly includes a frame coupled to the housing, a blade pivotally coupled to the frame, and a linkage assembly interconnecting the output member and the blade. The blade is pivotable relative to the frame about a pivot axis in response to movement of the output member along the drive axis.

### CROSS-REFERENCE TO RELATED APPLICATIONS

This application claims priority to co-pending U.S. Provisional Patent Application No. 63/126,361, filed Dec. 16, 2020, the entire content of which is incorporated herein by reference.

### BACKGROUND

The present invention relates to shearing tools, and more particularly to tools for shearing steel studs.

To enable metal stud shearing operations to occur at any area of a worksite, without the effort to take down, move, and set up a stud shearing apparatus, a handheld shearing tool is disclosed herein.

### SUMMARY

The invention provides, in one aspect, a shearing tool including a drive device and a shearing assembly. The drive device includes a housing and an output member linearly movable relative to the housing along a drive axis. The shearing assembly includes a frame coupled to the housing, a blade pivotally coupled to the frame, and a linkage assembly interconnecting the output member and the blade. The blade is pivotable relative to the frame about a pivot axis in response to movement of the output member along the drive axis.

The invention provides, in another aspect, a shearing assembly removably coupled to a drive unit. The shearing assembly includes a frame, a blade, and a guide. The frame may be removably coupled to a drive device. The blade has a pivot axis and is pivotally coupled to the frame and is pivotably relative to the frame. The blade is movably relative to the frame in response to movement of the drive device. A plurality of slots extend through the guide.

The invention provides, in another aspect, a guide for a shearing tool including first and second plates spaced apart and configured to receive a blade therebetween, a first slot extending through the first and second plates, and a plurality of second slots extending from the first slot. The plurality of second slots is configured to receive and guide workpieces having different nominal sizes.

Other features and aspects of the invention will become apparent by consideration of the following detailed description and accompanying drawings.

### BRIEF DESCRIPTION OF THE DRAWINGS

FIG. 1 is a perspective view of a shearing tool according to an embodiment of the present invention.

FIG. 2 is perspective view of the shearing tool of FIG. 1, illustrating a blade of the shearing tool in a raised position.

FIG. 3 is a perspective view of the shearing tool of FIG. 1, illustrating the blade in a lowered position.

FIG. 4 is an exploded view of the shearing tool of FIG. 1.

FIG. 5 is a schematic illustration of a shearing tool according to another embodiment of the present invention.

FIG. 6 is a schematic illustration of a shearing tool according to another embodiment of the present invention.

FIG. 7 is a schematic illustration of a shearing tool according to another embodiment of the present invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

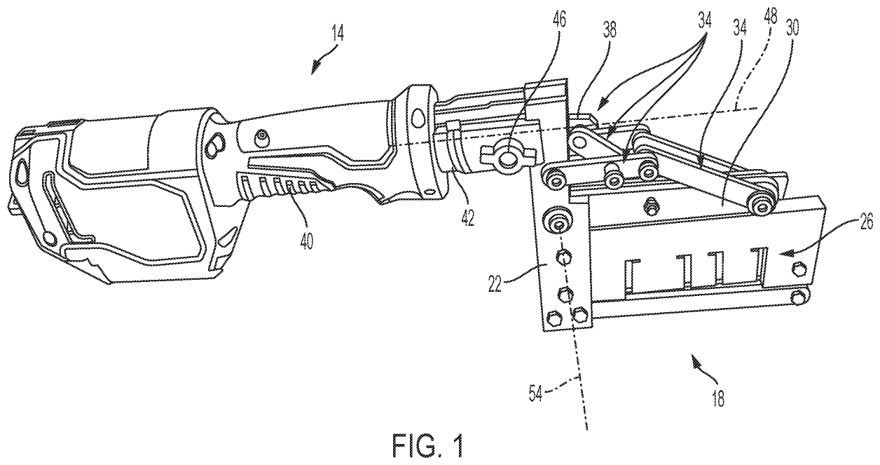

FIG. 1 illustrates a shearing tool 10 according to one embodiment. The shearing tool 10 includes a drive device 14 and a shearing assembly 18 coupled to the drive device 14. The shearing assembly 18 includes a frame 22, a guide 26 supported by the frame 22, a blade 30 pivotally coupled to the frame 22, and a linkage assembly 34 interconnecting the blade 30 with an output member 38 of the drive device 14.

With continued reference to FIG. 1, in the illustrated embodiment, the drive device 14 includes a housing 40, a clevis 42 fixed to the housing 40, and a pin 46 extending through the clevis 42 to couple the frame 22 to the clevis 42 (and thus, to the housing 40). The drive device 14 is operable to reciprocate the output member 38 relative to the clevis 42 along a drive axis 48. The drive device 14 may be any suitable tool having a linearly-movable output member but is preferably a motorized tool powered by a removable, rechargeable battery. For example, in the illustrated embodiment, the drive device 14 is a battery-powered crimping tool, such as the crimping tool described and illustrated in U.S. Pat. No. 10,213,821, issued to Milwaukee Electric Tool Corporation, the entire content of which is incorporated herein by reference. In such embodiments, the working assembly of the crimping tool is removed, and the frame 22 of the shearing assembly 18 is then coupled to the crimping tool (e.g., via the pin 46). In some embodiments, the shearing assembly 18 may be provided with the crimping tool as a kit (e.g., as an interchangeable working assembly).

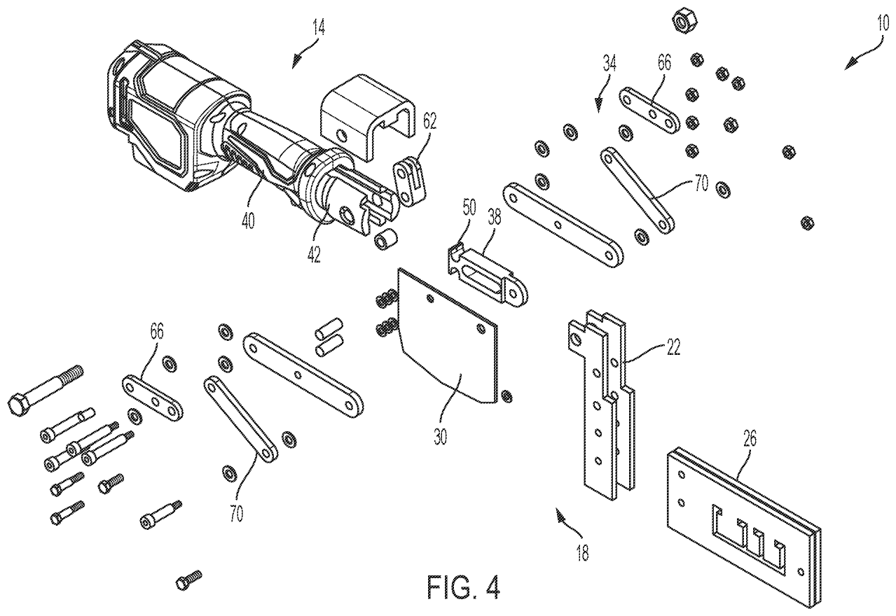

In some embodiments, the output member 38 may be an adapter removably coupled to an output of the drive device 14. For example, with reference to FIG. 4, the illustrated output member 38 includes a pair of arcuate recesses 50 configured to receive rollers on a roller carriage (not shown) of the drive device 14. The roller carriage may be advanced or retracted upon operation of the drive device 14, thereby linearly moving the output member 38. In other embodiments, the output member 38 may formed as an integral component of the drive device 14, or the output member 38 may be configured in other ways suitable for interfacing with the drive device 14.

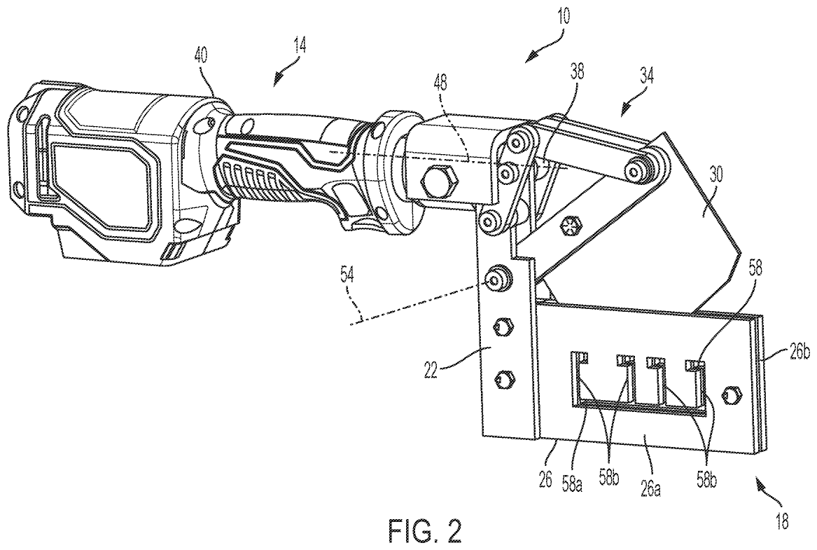

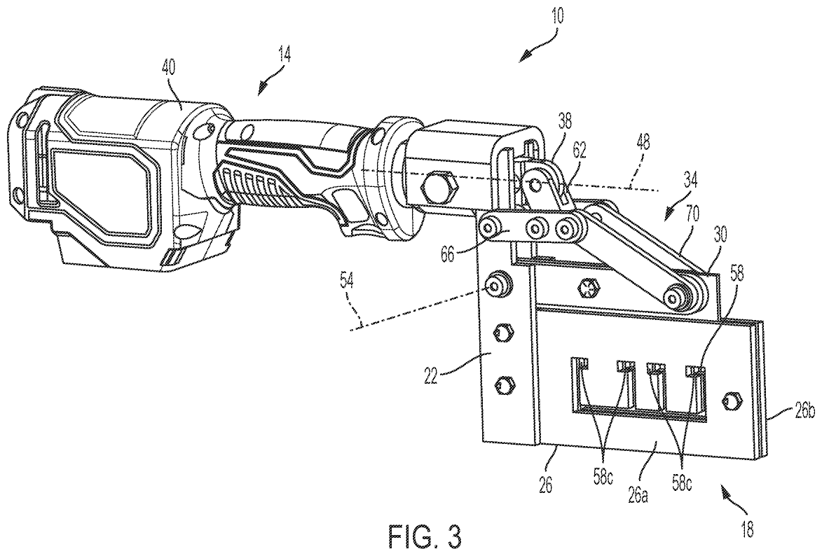

Referring to FIGS. 2-3, the blade 30 is pivotable about a pivot axis 54, which is orthogonal to the drive axis 48 in the illustrated embodiment, in response to linear movement of the output member 38 along the drive axis 48. The blade 30 is movable (e.g., pivotable) relative to the frame 22 and the guide 26 between a raised position (FIG. 2) and a lowered position (FIG. 3). In the illustrated embodiment, the blade 30 is received between two plates 26a, 26b of the guide 26. The plates 26a, 26b of the guide 26 may comprise metal, plastic, or other suitable material capable of withstanding the force applied by the drive device 14. A plurality of slots 58 extends transversely through the guide 26, and through the path of the blade 30. The slots 58 are preferably sized and shaped to receive a plurality of different standard/nominal sizes of workpieces, such as steel studs (e.g., used for construction framing). As presently embodied, the slots 58 accommodate steel studs having three different sizes, with one stud size having a nominally square cross-section and two other stud sizes having different, nominally rectangular cross-sections. The slots 58 of the guide 26 of the present embodiment include a first slot 58a and a plurality of second slots 58b extending perpendicularly from the first slot 58a. Each of the second slots 58b is generally L-shaped in the illustrated embodiment, with a flange portion 58c at a distal end of each second slot 58b, opposite the first slot 58a.

The second slots 58b are spaced along the first slot 58a in a manner corresponding to different stud widths. In the illustrated embodiment, the guide 26 includes four second slots 58b, such that the guide 26 is able to receive three differently sized studs or workpieces. Other cross-section geometries may be accommodated by the slots 58 in other embodiments. In some embodiments, the guide 26 may be interchangeable with a plurality of guides, each having slots 58 of different sizes/geometries.

The linkage assembly 34 interconnects the output member 38 and the blade 30. With reference to FIGS. 3-4, the illustrated linkage assembly 34 includes a first link 62, a second link 66, and a third link 70. The first link 62 is pivotally coupled to the output member 38 and to an intermediate portion of the second link 66. The second link 66 is pivotally coupled at one end to the frame 22 and at its opposite end to the third link 70. The third link 70 is pivotally coupled at one end to the second link 66 and at its opposite end to the blade 30. The links 62, 66, 70 pivot in response to movement of the output member 38 to convert linear movement of the output member 38 into pivotal movement of the blade 30 between the raised position (FIG. 2) and the lowered position (FIG. 3).

In operation, with the blade 30 in the raised position (FIG. 2), a user inserts a stud to be cut into the appropriately sized slot 58 in the guide 26. The user then operates the drive device 14, which advances the output member 38 toward the shearing assembly 18 along the drive axis 48. The linkage assembly 34 converts the linear movement of the output member 38 into pivotal movement of the blade 30 about the pivot axis 54. The blade 30 pivots toward the lowered position (FIG. 3) and shears the stud.

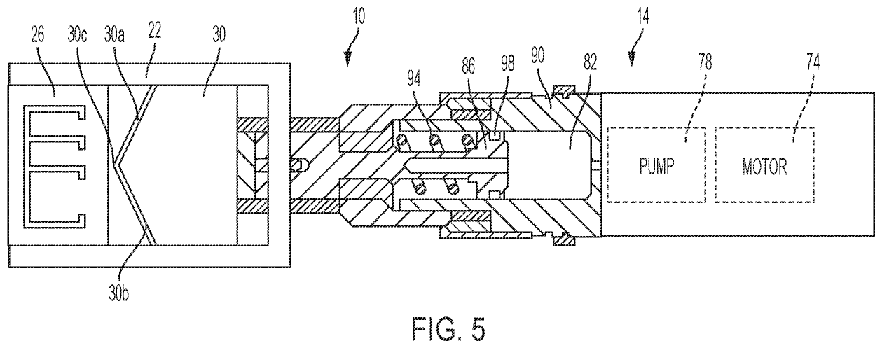

FIG. 5 illustrates a shearing tool 10 according to another embodiment. The shearing tool 10 of FIG. 5 is similar in some aspects to the shearing tool 10 described above with reference to FIGS. 1-4, and features of the shearing tool 10 of FIG. 5 corresponding to features of the shearing tool 10 of FIGS. 1-4 are given like reference numbers. In addition, it should be understood that features of the shearing tool 10 described above with reference to FIGS. 1-4 may be incorporated into the shearing tool 10 of FIG. 5, and vice versa.

Referring to FIG. 5, the drive device 14 of the shearing tool 10 is a hydraulic tool having a motor 74 that drives a hydraulic pump 78, which pumps hydraulic fluid from a reservoir (not shown) to a chamber 82. The chamber 82 is defined at one end by a piston 86, which is slidably disposed within a cylinder 90. As described in greater detail below, the hydraulic fluid imparts a force on the piston 86, causing the piston 86 to translate in the cylinder 90 (e.g., to the left with reference to the orientation illustrated in FIG. 5).

In the illustrated embodiment, a spring 94 engages a side of the piston 86 opposite the chamber 82 and imparts a return force opposite the hydraulic force applied to the piston 86 by the pressurized hydraulic fluid. A seal 98 is disposed circumferentially around the piston 86 for sealing the chamber 82 of hydraulic fluid. When the piston 86 reaches a desired position (e.g., an extended position) during operation, a dump valve (not shown) may release pressure from the chamber 82, allowing the spring 94 to return the piston 86 to its starting position (e.g., a retracted position). As such, the cylinder 90 may be referred to as a single-acting hydraulic cylinder. In other embodiments, the cylinder 90 may be a double-acting hydraulic cylinder, plumbed to receive pressurized hydraulic fluid on either side of the piston 86 to move the piston 86.

With continued reference to FIG. 5, the piston 86 is coupled to the blade 30 via an output member (such as the output member 38). The piston 86 may instead be integral with the output member 38. In the illustrated embodiment, the blade 30 moves linearly within the frame 22, but the blade 30 may be configured to pivot in other embodiments. In addition, the illustrated blade includes two edges 30a, 30b, which converge at an apex 30c. The edges 30a, 30b preferably intersect at an obtuse angle, which may facilitate cleanly shearing/cutting the workpiece.

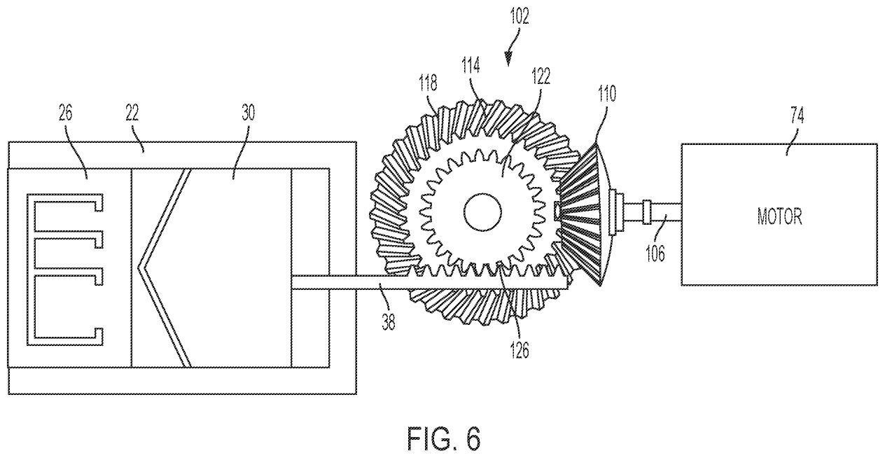

FIG. 6 illustrates a shearing tool 10 of another embodiment. The shearing tool 10 of FIG. 6 is similar in some aspects to the shearing tools 10 described above with reference to FIGS. 1-4 and 5, and features of the shearing tool 10 of FIG. 6 corresponding to features of the shearing tool 10 of FIGS. 1-4 or the shearing tool 10 of FIG. 5 are given like reference numbers. In addition, it should be understood that features of the shearing tools 10 described above with reference to FIGS. 1-4 and 5 may be incorporated into the shearing tool 10 of FIG. 6, and vice versa.

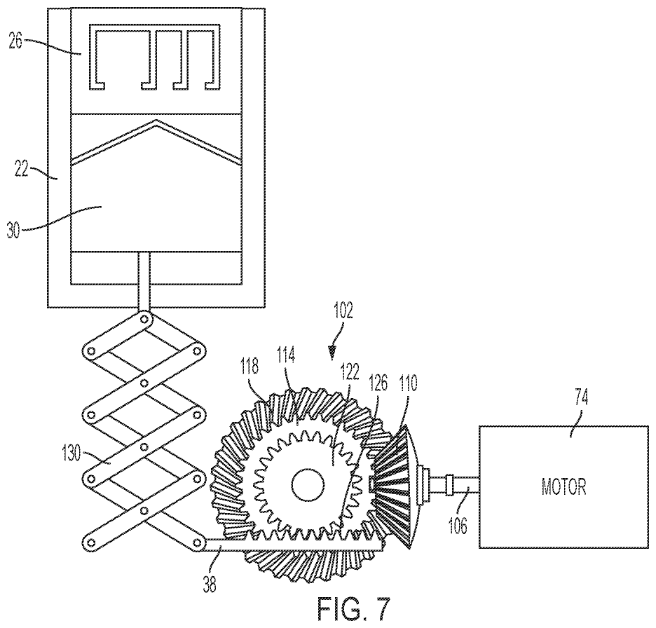

Referring to FIG. 6, the drive device 14 of the shearing tool 10 includes a motor 74 and a transmission assembly or gear assembly 102. The motor includes an output shaft 106 with an output gear 110 coupled to the output shaft 106 and rotatable therewith. The output gear 110 may be a bevel gear, or other suitable gear geometry for transfer of rotational motion. The transmission assembly 102 includes a transmission gear 114 engaged by the output gear 110. The transmission gear 114 includes an input portion 118 and a pinion portion 122. The input portion 118 may be a bevel gear or other suitable gear geometry engageable with the output gear 110. The pinion portion 122 may be a spur gear or other appropriate gear geometry. The pinion portion 122 engages an output member 38 having a rack 126 that is coupled to the blade 30, thereby transforming the rotational motion of the motor 74 to a linear displacement of the blade 30. As illustrated in FIG. 7, the output member 38 may instead be coupled to a blade 30 by an extension mechanism 130, which is configured as a scissor mechanism in the illustrated embodiment, facilitating increased travel of the blade 30 with a shorter stroke from the linear motion source (e.g., the rack 126).

Although the invention has been described in detail with reference to certain preferred embodiments, variations and modifications exist within the scope and spirit of one or more independent aspects of the invention as described.

Various features of the invention are set forth in the following claims.

What is claimed is:

1. A shearing tool comprising:
a drive device comprising
a housing, and
an output member linearly movable relative to the housing along a drive axis; and
a shearing assembly comprising
a frame coupled to the housing,
a blade disposed in and slidable in the frame in response to movement of the output member along the drive axis.

2. The shearing tool of claim 1, wherein the shearing assembly further comprises a linkage assembly interconnecting the output member and the blade.

3. The shearing tool of claim 2, wherein the blade is pivotally coupled to the frame such that the blade is pivotable relative to the frame about the pivot axis.

4. The shearing tool of claim 1, wherein the drive device further comprises
a motor having an output shaft, the motor being disposed in the housing, and
a transmission assembly disposed in the housing and engaged with the motor and the output member.

5. The shearing tool of claim 4,
wherein an output gear is disposed on the output shaft,
wherein the output member includes a rack, and
wherein the transmission assembly comprises a transmission gear having an input portion and a pinion portion, the input portion meshing with the output gear and the pinion portion meshing with the rack.

6. The shearing tool of claim 4, further comprising
an extension mechanism operably coupled between the output member and the blade.

7. The shearing tool of claim 6, wherein the extension mechanism includes a scissor mechanism.

8. The shearing tool of claim 1, wherein the drive device further comprises
a motor disposed in the housing,
a hydraulic pump coupled to the motor, the motor driving the hydraulic pump,
a cylinder in fluid communication with the hydraulic pump,
a piston disposed in the cylinder, the piston being coupled to the blade.

9. The shearing tool of claim 1, wherein the shearing assembly further comprises
a guide having a plurality of slots therethrough.

10. A shearing assembly comprising:
a frame removably couplable to a drive device,
a blade disposed in and coupled to the frame, the blade being movable in response to movement of the drive device, and
a guide having a plurality of slots therethrough, the guide being disposed in the frame.

11. The shearing assembly of claim 10, further comprising a linkage assembly interconnecting the drive device and the blade.

12. The shearing assembly of claim 10, wherein the guide includes a first plate and a second plate, and wherein the blade is received between the first plate and the second plate.

13. The shearing assembly of claim 10, wherein the plurality of slots includes a first slot and a plurality of second slots extending from the first slot.

14. The shearing assembly of claim 13, wherein each of the plurality of second slots includes a flange portion at an end opposite the first slot.

15. The shearing assembly of claim 13, wherein the plurality of second slots includes four second slots spaced along a length of the first slot.

16. The shearing assembly of claim 10, wherein the guide is configured to receive and guide workpieces of a plurality of different nominal sizes.

17. The shearing assembly of claim 16, wherein the guide is configured to receive and guide workpieces of three different nominal sizes.

18. A guide for a shearing tool comprising:
first and second plates spaced apart and configured to receive a blade therebetween;
a first slot extending through the first and second plates; and
a plurality of second slots extending from the first slot,
wherein the plurality of second slots is configured to receive and guide workpieces having different nominal sizes.

19. The guide of claim 18, wherein the plurality of second slots includes four second slots spaced along a length of the first slot.

20. The guide of claim 18, wherein each of the plurality of second slots includes a flange portion formed at an end of the second slot opposite the first slot.
